(19) United States
(12) Patent Application Publication
(10) Pub. No.: US 2026/0341873 A1
(43) Pub. Date: Oct. 29, 2026

(54) BATTERY PACK

(71) Applicant: TOYOTA JIDOSHA KABUSHIKI KAISHA, Toyota-shi (JP)

(72) Inventors: Koichi YANASE, Nagoya-shi (JP); Takuya ARAKAWA, Nagakute-shi (JP); Makoto IWATA, Toyota-shi (JP); Kenta KIMURA, Nagoya-shi (JP); Ryo KIMURA, Nagoya-shi (JP); Kunihiro TSUNEKAWA, Toyota-shi (JP); Osamu YAMASHITA, Toyota-shi (JP)

(73) Assignee: TOYOTA JIDOSHA KABUSHIKI KAISHA, Toyota-shi (JP)

(21) Appl. No.: 19/556,299

(22) Filed: Mar. 4, 2026

(30) Foreign Application Priority Data
Apr. 23, 2025 (JP) 2025-071873

(51) Int. Cl. H01M 50/242; H01M 50/249; H01M 50/264; H01M 50/291

(52) U.S. Cl. CPC H01M 50/242; H01M 50/249; H01M 50/264; H01M 50/291

(57) ABSTRACT

The battery pack may include a plurality of battery modules and a casing that houses the battery modules. Each of the battery modules may extend from a first end to a second end in a first direction, and the battery modules may be arranged along a second direction orthogonal to the first direction. Each of the battery modules may include, at either or both of the first end and the second end, a protruding portion that protrudes in the second direction. Among the battery modules, the protruding portions of two adjacent battery modules may face each other in the second direction.

### CROSS-REFERENCE TO RELATED APPLICATION

This application claims priority to Japanese Patent Application No. 2025-071873 filed on Apr. 23, 2025. The disclosure of the above-identified application, including the specification, drawings, and claims, is incorporated by reference herein in its entirety.

### BACKGROUND

### 1. Technical Field

The technology disclosed in the present specification relates to battery packs.

### 2. DESCRIPTION OF RELATED ART

US Unexamined Patent Application Publication No. 2017/0365887 describes a battery pack for use in an electrified vehicle. This battery pack includes a plurality of battery modules and a casing that houses the battery modules.

### SUMMARY

The battery pack described above is provided with a reinforcing member that extends in the vehicle width direction inside the casing. Such a reinforcing member can increase the rigidity of the casing in the vehicle width direction. However, providing the reinforcing member may increase the size of the battery pack. This specification provides a technology that enables the battery pack to be made relatively compact while ensuring the rigidity of the casing.

The technology disclosed in the present specification is embodied in a battery pack. The battery pack may include a plurality of battery modules and a casing that houses the battery modules. Each of the battery modules may extend from a first end to a second end in a first direction, and the battery modules may be arranged along a second direction orthogonal to the first direction. Each of the battery modules may include, at either or both of the first end and the second end, a protruding portion that protrudes in the second direction. Among the battery modules, the protruding portions of two adjacent battery modules may face each other in the second direction.

In the above configuration, when a load is applied to the casing in the second direction, the battery modules are connected together through the protruding portions. As a result, the battery modules function as a reinforcing member extending in the second direction inside the casing. Accordingly, in the battery pack, the number of reinforcing member provided in the casing can be reduced while ensuring the rigidity of the casing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a battery pack according to a first embodiment;

FIG. 2 is a sectional view of the battery pack taken along line II-II in FIG. 1;

FIG. 3 is a plan view of a battery pack according to a second embodiment; and

FIG. 4 is a plan view of a battery pack according to a third embodiment.

### DETAILED DESCRIPTION OF EMBODIMENTS

In one embodiment of the present technology, each of the battery modules may include the protruding portion at both the first end and the second end. In this case, the battery modules can function as a more robust reinforcing member.

In the above embodiment, the battery modules may include a first battery module located at a first end in the second direction and a second battery module located at a second end in the second direction. In this case, the first battery module may be fixed to the casing with one or more bolts. The battery pack may further include a first biasing member configured to bias the second battery module toward the first battery module. With such a configuration, all of the battery modules can be fixed to the casing simply by fixing the first battery module among the battery modules to the casing.

In one embodiment of the present technology, each of the battery modules may be fixed to the casing at the first end with one or more bolts. In this case, the battery pack may further include one or more second biasing members configured to bias the battery modules from the second ends toward the first ends. With this configuration, the battery modules can be fixed to the casing simply by fixing the first ends of the battery modules to the casing. Since the second ends of the battery modules are not fixed to the casing, the number of bolts can be reduced.

In one embodiment of the present technology, the second biasing member may be constructed using a structure that is in the form of a sheet and that has elasticity. With such a configuration, the second biasing member can be efficiently disposed in the limited space inside the casing.

### First Embodiment

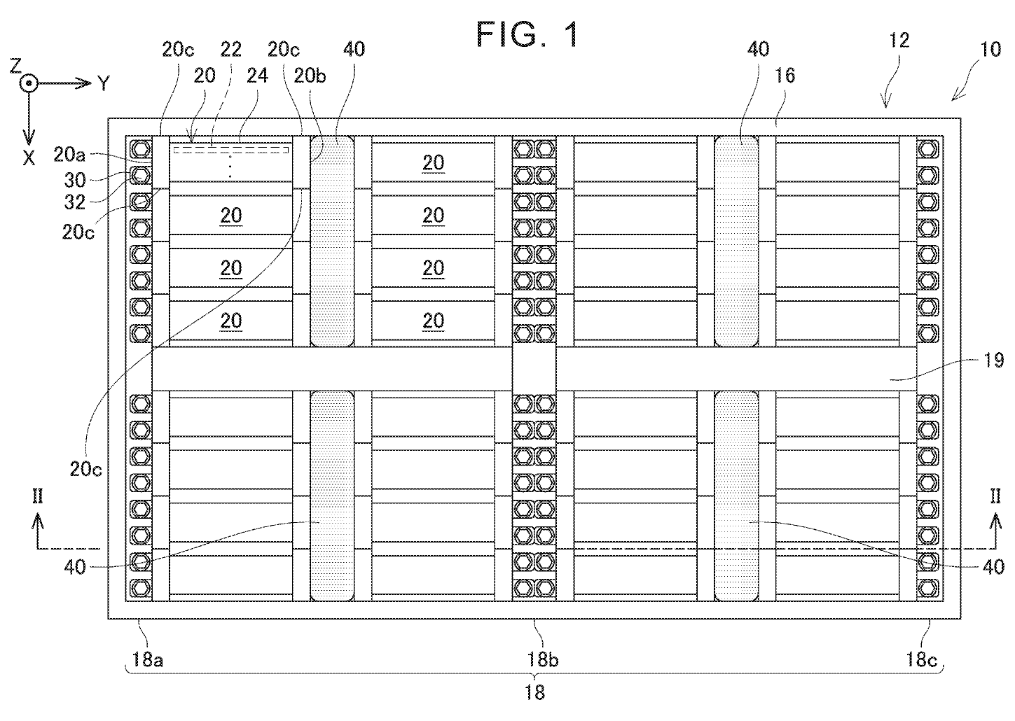

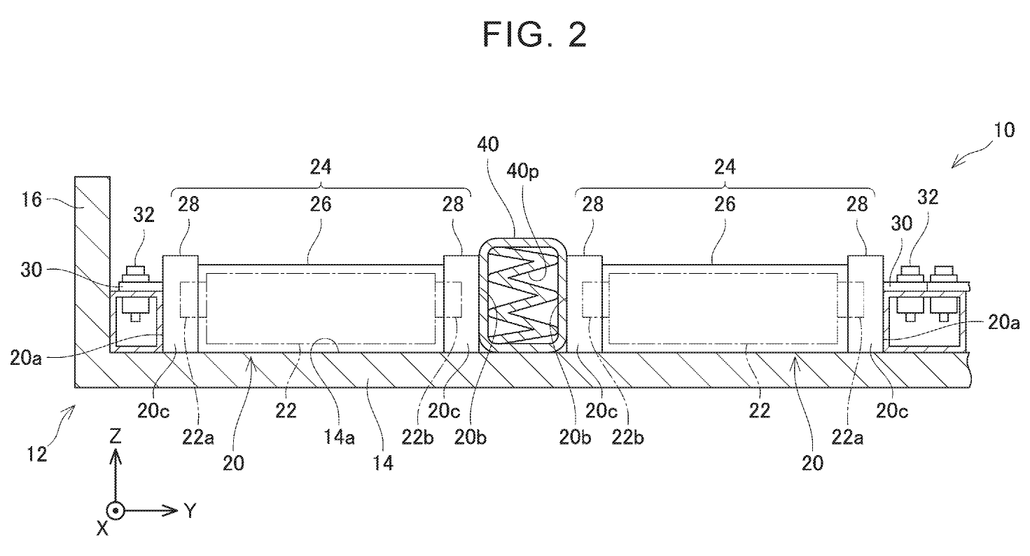

A battery pack 10 according to a first embodiment will now be described with reference to FIGS. 1 and 2. The battery pack 10 of the present embodiment can be mounted on, for example, a vehicle. The vehicle is, for example, a battery electric vehicle (BEV). However, the vehicle is not limited to a BEV, and may be another type of electrified vehicle such as a hybrid electric vehicle (HEV) or a plug-in hybrid electric vehicle (PHEV). The battery pack 10 can supply electric power to a motor that drives the wheels of the vehicle.

As shown in FIGS. 1 and 2, the battery pack 10 includes a plurality of battery modules 20, a casing 12, and a plurality of biasing members 40. The casing 12 houses the battery modules 20. The casing 12 is a box-shaped member having a bottom, and has a bottom wall 14 (FIG. 2) and a peripheral wall 16. The casing 12 is made of, for example, metal. The bottom wall 14 is a substantially rectangular flat plate member. An upper surface 14a of the bottom wall 14 has a substantially rectangular shape. The peripheral wall 16 is a tubular member and extends upward from the outer peripheral edge of the upper surface 14a of the bottom wall 14. The peripheral wall 16 extends along the entire outer peripheral edge of the upper surface 14a of the bottom wall 14.

Each of the battery modules 20 has a first end 20a and a second end 20b. Each battery module 20 extends from the first end 20a to the second end 20b along the longitudinal direction of the bottom wall 14. The battery modules 20 are arranged in a matrix on the upper surface 14a of the bottom wall 14, along both the longitudinal direction of the upper surface 14a of the bottom wall 14 and the width direction of the upper surface 14a of the bottom wall 14 that is orthogonal to the longitudinal direction.

In the drawings, the longitudinal direction of the upper surface 14a of the bottom wall 14 (also referred to as the longitudinal direction of the battery pack 10) is indicated by the Y-axis. One side in the longitudinal direction is indicated as the negative direction of the Y-axis, and the other side in the longitudinal direction is indicated as the positive direction of the Y-axis. The width direction of the upper surface 14a of the bottom wall 14 that is orthogonal to the longitudinal direction (hereinafter also referred to as the width direction of the battery pack 10) is indicated by the X-axis. One side in the width direction is indicated as the negative direction of the X-axis, and the other side in the width direction is indicated as the positive direction of the X-axis. The up-down direction of the battery pack 10 perpendicular to the upper surface 14a (i.e., the XY-plane) of the bottom wall 14 of the battery pack 10 is indicated by the Z-axis. The upper side in the up-down direction is indicated as the positive direction of the Z-axis, and the lower side in the up-down direction (i.e., the side in the direction in which the battery pack 10 is viewed in plan) is indicated as the negative direction of the Z-axis.

The casing 12 includes a plurality of beams 18, 19 fixed to the upper surface 14a of the bottom wall 14. The beams 18 are reinforcing members of the casing 12. The beams 18 extend along the upper surface 14a of the bottom wall 14. Each beam 18 has, for example, a tubular or hat-shaped cross section. The cross section as used herein refers to a cross section obtained by cutting the beam 18 along a plane perpendicular to the longitudinal direction of the beam 18. The beams 18, 19 include a plurality of first beams 18a, 18b, 18c (also collectively referred to as the first beams 18) that extend in the width direction of the battery pack 10, and a second beam 19 that extends in the longitudinal direction of the battery pack 10. The beam 19 is located at the center in the width direction of the battery pack 10. The first beam 18a is adjacent to a first longitudinal end of the peripheral wall 16. The first beam 18c is adjacent to a second longitudinal end of the peripheral wall 16. The first beam 18b is located between the first beams 18a and 18c. The first beam 18b is located at the center in the longitudinal direction of the bottom wall 14. The first beams 18 extend across the second beam 19. In one example, the first beams 18 are arranged so as to fit with the second beam 19.

The casing 12 is partitioned into four chambers by the first beams 18 and the second beam 19, although the configuration of the casing 12 is not limited to this. In each of the four chambers, the battery modules 20 are arranged in two rows in the longitudinal direction of the battery pack 10 and four columns in the width direction of the battery pack 10. However, the arrangement and number of battery modules 20 in each chamber are not limited to this. For example, the battery modules 20 in each chamber may be arranged in two rows in the longitudinal direction and two columns in the width direction.

Each battery module 20 includes a plurality of battery cells 22, a module casing 24, and a plurality of fixing portions 30. Each battery cell 22 is a rechargeable secondary battery cell. The secondary battery cell is, for example, a lithium-ion battery cell. Each battery cell 22 has a flat shape. Each battery cell 22 is, for example, a pouch battery cell (also referred to as a laminate battery cell). Each battery cell 22 has electrode tabs respectively at both ends 22a, 22b in the longitudinal direction of the battery pack 10. The battery cells 22 are stacked in the thickness direction of the battery cells 22 (i.e., the width direction of the battery pack 10). The module casing 24 houses the battery cells 22. The module casing 24 is made of, for example, resin. The module casing 24 has a generally rectangular-parallelepiped shape. Although not shown in the figures, the module casing 24 is open downward. The end faces of the battery cells 22 are exposed to the outside of the module casing 24 through the opening of the module casing 24. The module casing 24 includes a casing body 26 and a pair of covers 28. The covers 28 are located respectively at the longitudinal ends 20a, 20b of the battery module 20. The covers 28 respectively cover the ends 22a, 22b of the battery cells 22.

The fixing portions 30 are provided at the first end 20a of each battery module 20. The first end 20a of the battery module 20 is fixed to the casing 12 at the fixing portions 30. Each of the fixing portions 30 is fastened to the first beam 18 of the casing 12 with a bolt 32. However, the number of fixing portions 30 and bolts 32 at the first end 20a is not limited to two, and may be one, or three or more.

Among the battery modules 20 arranged in each chamber of the casing 12, a biasing member 40 is disposed between two battery modules 20 that are adjacent in the longitudinal direction of the battery pack 10. The biasing member 40 is sandwiched between the second ends 20b of the two adjacent battery modules 20. The biasing member 40 biases the second ends 20b of the adjacent battery modules 20 toward their first ends 20a. With this configuration, the battery modules 20 can be fixed to the casing 12 simply by fixing the first ends 20a of the battery modules 20 to the casing 12. Since the second ends 20b of the battery modules 20 are not fixed to the casing, the number of bolts 32 can be reduced.

Each biasing member 40 is elastically deformable in the width direction of the battery pack 10. Each biasing member 40 is constructed using a structure in the form of a sheet having elasticity. With such a configuration, the biasing members 40 can be efficiently arranged in the limited space inside the casing 12. In one example, each biasing member 40 is a spring member. In a modification, each biasing member 40 may be constructed using, for example, a micro-bridge structure. In another modification, each biasing member 40 may be constructed using, for example, a sheet member in the form of a gel. In each chamber of the casing 12, one biasing member 40 biases eight battery modules 20 adjacent to the biasing member 40. The number of biasing members 40 in each chamber may be one, or may be two or more. The number of biasing members 40 may be modified as appropriate depending on the number of battery modules 20 arranged in the casing 12 and the arrangement of the battery modules 20.

Each biasing member 40 extends across the second ends 20b of the battery modules 20 arranged along the width direction of the battery pack 10. Specifically, in each chamber of the casing 12, the biasing member 40 is sandwiched between a plurality of battery modules 20 arranged along the width direction and another plurality of battery modules 20 arranged along the width direction. Accordingly, each biasing member 40 biases each of the battery modules 20 arranged along the width direction from the second end 20b toward the first end 20a. With this configuration, the biasing member 40 can be shared among the battery modules arranged along the width direction.

In one example, a cooling path 40p through which a heat medium flows is formed inside each biasing member 40. The cooling path 40p extends, for example, along the width direction of the battery pack 10. When the cooling path 40p is formed inside the biasing member 40, the biasing member 40 can also be used for cooling. This enables further reduction in size of the battery pack 10.

The second end 20b of each battery module 20 has a pair of protruding portions 20c. The protruding portions 20c protrude respectively toward both sides in the width direction (X-axis direction) of the battery pack 10. Each protruding portion 20c protrudes beyond the casing body 26 of the module casing 24 in the width direction. That is, the width dimension of the pair of covers 28 including the protruding portions 20c in the width direction of the battery pack 10 is greater than the width dimension of the casing body 26 in the width direction of the battery pack 10. Among the battery modules 20 arranged along the width direction of the battery pack 10 in each chamber of the casing 12, the protruding portions 20c of two adjacent battery modules 20 face each other in the width direction. In each chamber of the casing 12, as with the second end 20b, the first end 20a of each battery module 20 also has a pair of protruding portions 20c.

As described above, in the battery pack 10 of the present embodiment, the protruding portions 20c of two battery modules 20 adjacent in the width direction of the battery pack 10 face each other. With such a configuration, when a load is applied to the casing 12 in the width direction (X-axis direction) due to, for example, a vehicle collision, the battery modules 20 are connected together through the protruding portions 20c at the second ends 20b of the battery modules 20. As a result, the battery modules 20 function as a reinforcing member extending in the width direction inside the casing 12. Accordingly, in the battery pack 10, the number of first beams 18 provided in the casing 12 can be reduced while ensuring the rigidity of the casing 12.

In particular, in the present embodiment, the protruding portions 20c of two battery modules 20 adjacent in the width direction of the battery pack 10 face each other not only at the second ends 20b but also at the first ends 20a. In this case, the battery modules 20 can function as a more robust reinforcing member. The longitudinal direction of the battery pack 10 is an example of the "first direction" in the present technology, and the width direction of the battery pack 10 is an example of the "second direction" in the present technology. The biasing members 40 are an example of the "second biasing member" in the present technology.

### Second Embodiment

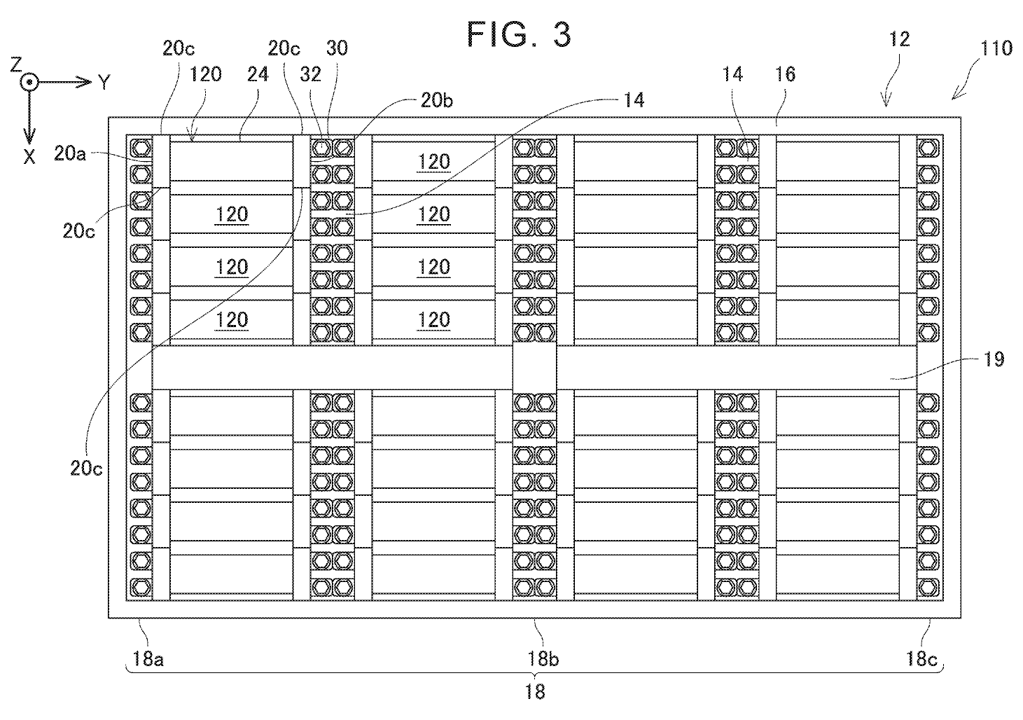

A battery pack 110 according to a second embodiment will now be described with reference to FIG. 3. as shown in FIG. 3, the battery pack 110 of the second embodiment does not include the biasing members 40. the second end 20b of each battery module 120 in the battery pack 110 is fixed to the casing 12 with a plurality of bolts 32 instead of by a biasing member 40. the fixing portions 30 are provided at the second end 20b of each battery module 120. each battery module 120 is fixed directly to the upper surface 14a of the bottom wall 14 of the casing 12 via the fixing portions 30. in this respect, the battery pack 110 of the present embodiment differs from the battery pack 10 of the first embodiment. the configuration of the battery pack 110 may otherwise be the same as that of the battery pack 10 of the first embodiment. that is, in the present embodiment as well, the protruding portions 20c of two battery modules 120 adjacent in the width direction of the battery pack 110 face each other. with such a configuration, the battery modules 120 are connected together through the protruding portions 20c. as a result, the battery modules 120 function as a reinforcing member extending in the width direction inside the casing 12.

### Third Embodiment

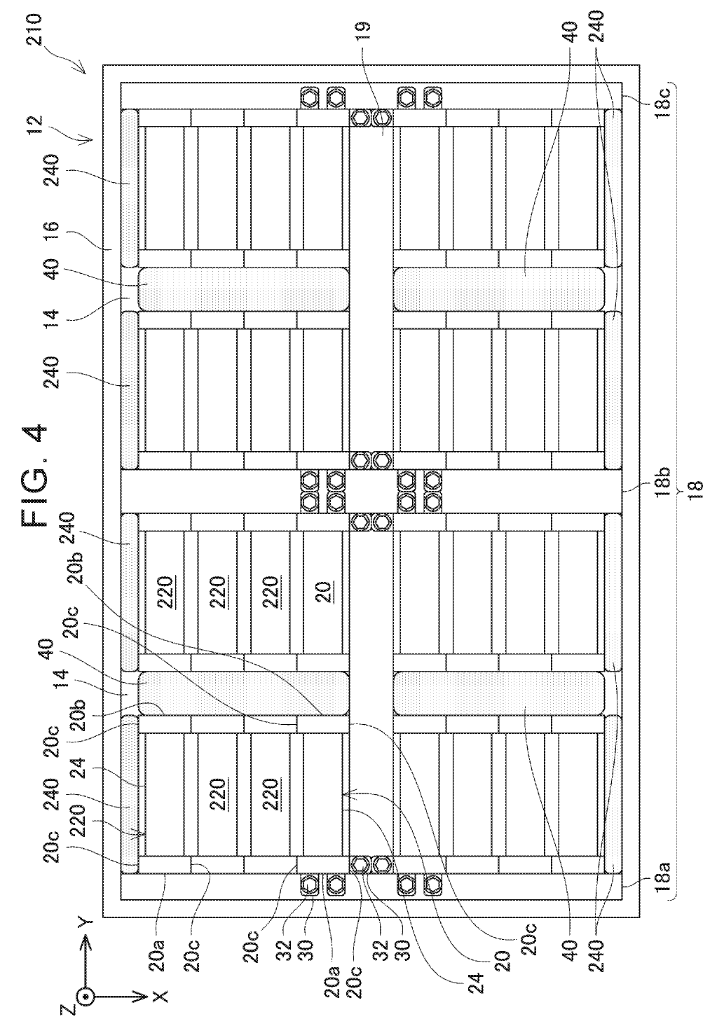

A battery pack 210 according to a third embodiment will now be described with reference to FIG. 4. As shown in FIG. 4, the battery pack 210 of the present embodiment includes, in addition to the configuration of the battery pack 10 of the first embodiment, a plurality of second battery modules 220 that does not have fixing portions 30, and a plurality of second biasing members 240. In this respect, the battery pack 210 of the third embodiment differs from the battery pack 10 of the first embodiment. The configuration of the battery pack 210 may otherwise be the same as that of the battery pack 10 of the first embodiment. In the battery pack 210, the battery modules 20, 220 include a plurality of battery modules 20 that is the same as those in the first embodiment, and a plurality of second battery modules 220.

The battery modules 20, 220 arranged in each chamber of the casing 12 will now be described. Each battery module 20 is adjacent to the second beam 19. Each second battery module 220 is located closer to the peripheral wall 16 than the battery modules 20. That is, among the battery modules 20, 220 arranged along the width direction of the battery pack 210, the battery module 20 is located at the end on the second beam 19 side in the width direction of the battery pack 210. In each battery module 20 located at the end on the second beam 19 side, the first end 20a is fixed to the second beam 19 of the casing 12 with a bolt 32. In each battery module 20 located at the end on the second beam 19 side, the second end 20b is biased toward the first end 20a by the biasing member 40.

Among the battery modules 20, 220 arranged along the width direction of the battery pack 210, the second battery module 220 is located at the end on the peripheral wall 16 side in the width direction. A second biasing member 240 is disposed between each second battery module 220 located at the end on the peripheral wall 16 side and the peripheral wall 16. Among the battery modules 20, 220, each second battery module 220 located at the end on the peripheral wall 16 side is biased toward the battery module 20 by the second biasing member 240. With such a configuration, all of the battery modules 20, 220 arranged along the width direction of the battery pack 210 can be fixed to the casing 12 simply by fixing the battery modules 20 among the battery modules 20, 220 to the casing 12.

In the present embodiment as well, the protruding portions 20c of two battery modules 20, 220 adjacent in the width direction of the battery pack 210 face each other. Even when a gap is provided between each second battery module 220 adjacent to the peripheral wall 16 of the casing 12 and the peripheral wall 16 as in the present embodiment, the battery modules 20, 220 are connected together through the protruding portions 20c at the first ends 20a and second ends 20b of the battery modules 20, 220 when a load is applied to the casing 12 in the width direction (X-axis direction) due to, for example, a vehicle collision. As a result, the battery modules 20, 220 function as a reinforcing member extending in the width direction inside the casing 12.

Each second biasing member 240 is a spring member, although the second biasing members 240 are not particularly limited to the spring members. Each second biasing member 240 may be configured in the same manner as the biasing member 40 of the first embodiment. However, each second biasing member 240 may be constructed from a member different from the biasing member of the first embodiment, as long as it is constructed using a structure in the form of a sheet having elasticity.

In a modification, among the battery modules 20, 220 arranged along the width direction, the battery module 20 that is fixed to the casing 12 with a bolt 32 may be located at the end on the peripheral wall 16 side in the width direction. In this case, the second biasing member 240 may be disposed between the second beam 19 and the second battery module 220 located at the end on the second beam 19 side in the width direction. For the battery modules 20, 220 arranged along the width direction, the number of second battery modules 220 arranged between the battery module 20 located at the end on the second beam 19 side in the width direction and the second battery module 220 located at the end on the peripheral wall 16 side in the width direction is not limited to two, and may be one, or three or more. There may be no second battery module 220 between the battery modules 20, 220 located at both ends in the width direction.

The battery module 20 located at the end on the second beam 19 side is an example of the "first battery module" in the present technology, and the second battery module 220 located at the end on the peripheral wall 16 side is an example of the "second battery module" in the present technology. The second biasing member 240 is an example of the "first biasing member" in the present technology.

What is claimed is:

1. A battery pack comprising:
a plurality of battery modules; and
a casing that houses the battery modules, wherein:
each of the battery modules extends from a first end to a second end in a first direction, and the battery modules are arranged along a second direction orthogonal to the first direction;
each of the battery modules includes, at either or both of the first end and the second end, a protruding portion that protrudes in the second direction; and
among the battery modules, the protruding portions of two adjacent battery modules face each other in the second direction.

2. The battery pack according to claim 1, wherein each of the battery modules includes, at both the first end and the second end, the protruding portion that protrudes in the second direction.

3. The battery pack according to claim 1, wherein:
the battery modules include a first battery module located at a first end in the second direction and a second battery module located at a second end in the second direction;
the first battery module is fixed to the casing with one or more bolts; and
the battery pack further includes a first biasing member configured to bias the second battery module toward the first battery module.

4. The battery pack according to claim 1, wherein:
each of the battery modules is fixed to the casing at the first end with one or more bolts; and
the battery pack further includes one or more second biasing members configured to bias the battery modules from the second ends toward the first ends.

5. The battery pack according to claim 4, wherein the second biasing member is constructed using a structure that is in a form of a sheet and that has elasticity.
